(19) United States
(12) Patent Application Publication
(10) Pub. No.: US 2021/0292585 A1
(43) Pub. Date: Sep. 23, 2021

(54) AQUEOUS INKJET INK

(71) Applicant: Hewlett-Packard Development Company, L.P., Spring, TX (US)

(72) Inventor: Raymond Adamic, Corvallis, OR (US)

(21) Appl. No.: 17/267,353

(22) PCT Filed: Dec. 18, 2018
(86) PCT No.: PCT/US2018/066213

§ 371 Date: Feb. 9, 2021

(51) Int. Cl. C09D 11/38; C09D 11/326; C09D 11/322; C09D 11/107; C09D 11/102; B41M 5/00

(52) U.S. Cl. CPC C09D 11/38; C09D 11/326; C09D 11/322; C08K 5/053; C09D 11/102; B41M 5/0023; C09D 11/107

(57) ABSTRACT

An example of an aqueous inkjet ink includes a wetting package, a co-solvent, a colorant, and a balance of water. The wetting package includes a 1,2-alkanediol having 10 or more carbon atoms, and a free dispersant. Examples of the aqueous inkjet ink may be used in printing methods with a substrate selected from the group consisting of a vinyl substrate, a polyvinylchloride substrate, a stainless steel substrate, a silicon substrate, an acrylic substrate, an acrylate substrate, a polyethylene substrate, and a non-treated polypropylene substrate.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a diagram illustrating an example of a printing method disclosed herein;

FIG. 2 depicts a black and white reproduction of an originally colored photograph of example aqueous inkjet inks applied on offset coated media and comparative example aqueous inkjet inks applied on offset coated media;

FIGS. 3A through 3D depict black and white reproductions of originally colored photographs of example aqueous inkjet inks applied on offset coated media (FIGS. 3C and 3D) and comparative example aqueous inkjet inks applied on offset coated media (FIGS. 3A and 3B);

FIGS. 4A and 4B depict black and white reproductions of originally colored photographs of images created on offset coated media using an example aqueous inkjet ink (FIG. 4B) and using a comparative example aqueous inkjet ink (FIG. 4A); and

FIGS. 5A through 5D depict black and white reproductions of originally colored photographs of images created on a vinyl medium using three example aqueous inkjet inks (FIGS. 5B through 5D) and using a comparative example aqueous inkjet ink (FIG. 5A).

### DETAILED DESCRIPTION

Disclosed herein is an aqueous inkjet ink including a wetting package that improves the ability of the aqueous inkjet ink to effectively wet a low energy, hydrophobic medium. The wetting package disclosed herein includes at least a 1,2-alkanediol having 10 or more carbon atoms. The 1,2-alkanediol having 10 or more carbon atoms creates an oil/water emulsion with the water in the aqueous inkjet ink. This oil/water emulsion enables the aqueous inkjet ink to effectively wet different examples of low energy, hydrophobic media.

The 1,2-alkanediol having 10 or more carbon atoms may be referred to herein as “1,2-alkanediol” or “higher carbon 1,2-alkanediol”. When these terms are used, it is to be understood that the terms are referring to the 1,2-alkanediol having 10 or more carbon atoms, and are not meant to include 1,2-alkanediols having a lower number of carbon atoms (such as 1,2-octanediol, 1,2-hexanediol, etc.).

The improved wettability of the aqueous inkjet ink on low energy, hydrophobic media may reduce or eliminate coalescence and mottling of the ink on the low energy, hydrophobic media. The improved wettability may also result in improved uniformity of the aqueous inkjet ink on the low energy, hydrophobic media. Further, the improved wettability may increase the efficiency of the aqueous ink on the low energy, hydrophobic media, which may result in reduced dry time and improved print durability.

Throughout this disclosure, a weight percentage that is referred to as “wt % active” refers to the loading of an active component of a dispersion or other formulation that is present in the aqueous inkjet ink. For example, a pigment may be present in a water-based formulation (e.g., a stock solution or dispersion) before being incorporated into the aqueous inkjet ink. In this example, the wt % actives of the pigment accounts for the loading (as a weight percent) of the pigment that is present in the aqueous inkjet ink, and does not account for the weight of the other components (e.g., water, etc.) that are present in the formulation with the pigment. The term “wt %,” without the term actives, refers to either i) the loading (in the aqueous inkjet ink) of a 100% active component that does not include other non-active components therein, or ii) the loading (in the aqueous inkjet ink) of a material or component that is used “as is” and thus the wt % accounts for both active and non-active components.

Aqueous Inkjet Inks

Disclosed herein is an aqueous inkjet ink that includes a wetting package. As mentioned above, the wetting package may improve the ability of the aqueous inkjet ink to effectively to wet low energy, hydrophobic media.

In an example, the aqueous inkjet ink, comprises: a wetting package including: a 1,2-alkanediol having 10 or more carbon atoms; and a free polymeric dispersant; a co-solvent; a colorant; and a balance of water. As will be discussed in more detail below, the phrase “free polymeric dispersant” means that the polymeric dispersant is not absorbed or attached to another ink component.

In another example, the aqueous inkjet ink, consists of: a wetting package consisting of: a 1,2-alkanediol having 10 or more carbon atoms; or the 1,2-alkanediol having 10 or more carbon atoms and 1,2-hexanediol; or the 1,2-alkanediol having 10 or more carbon atoms, 1,2-octanediol, and 1,2-hexanediol; a polymeric dispersant; a co-solvent selected from the group consisting of lactams, formamides, acetamides, and long chain alcohols; a colorant; an additive selected from the group consisting of a surfactant, a saccharide, an anti-kogation agent, an anti-decel agent, a biocide, a chelating agent, a rheology modifier, a pH adjuster, and a combination thereof, wherein: the surfactant is selected from the group consisting of an anionic surfactant, a fluorine surfactant, a biosurfactant, a polyoxyethylene alkyl ether, a polyoxyethylene alkyl phenyl ether, a polyoxyethylene fatty acid ester, a sorbitan fatty acid ester, a polyoxyethylene sorbitan fatty acid ester, a polyoxyethylene sorbitol fatty acid ester, a glycerin fatty acid ester, a polyoxyethylene glycerin fatty acid ester, a polyglycerin fatty acid ester, a polyoxyethylene alkylamine, a polyoxyethylene fatty acid amide, an alkylalkanolamide, a polyethylene glycol polypropylene glycol block copolymer, an acetylene glycol, and a polyoxyethylene adduct of acetylene glycol; and the chelating agent is selected from the group consisting of 4,5-dihydroxy-1,3-benzenedisulfonic acid disodium salt monohydrate; ethylenediaminetetraacetic acid; and hexamethylenediamine tetra(methylene phosphonic acid), potassium salt; and a balance of water.

In still another example, the aqueous inkjet ink, comprises: a 1,2-alkanediol having 10 or more carbon atoms; a dispersant; a co-solvent; a colorant; and a balance of water; wherein the aqueous inkjet ink is devoid of a polyorganosiloxane, devoid of a polyalkylene glycol, devoid of a chelating agent, and devoid of a polyvalent alcohol.

In some examples, the aqueous inkjet ink is devoid of a polyorganosiloxane. In other examples, the aqueous inkjet ink is devoid of a polyalkylene glycol. In still other examples, the aqueous inkjet ink is devoid of a chelating agent. In yet other examples, the aqueous inkjet ink is devoid of a polyvalent alcohol.

As used herein, the term “devoid of”, when referring to a component (such as, e.g., a polyorganosiloxane, a polyalkylene glycol, a chelating agent, or a polyvalent alcohol), may refer to a composition that does not include any added amount of the component, but may contain residual amounts, such as in the form of impurities. The components may be present in trace amounts, and in one aspect, in an amount of less than 0.1 weight percent (wt %) based on the total weight of the composition (e.g., the build material composition), even though the composition is described as being “devoid of” the component. In other words, “devoid of” a component may mean that the component is not specifically included, but may be present in trace amounts or as an impurity inherently present in certain ingredients.

Wetting Packages

As mentioned above, the wetting package includes at least the 1,2-alkanediol having 10 or more carbon atoms. In some examples, the wetting package may consist of the 1,2-alkanediol having 10 or more carbon atoms with no other components. In other examples, the wetting package includes additional components, such as 1,2-hexanediol, a polymeric dispersant, or a combination thereof. In one of these examples, the wetting package may consist of the 1,2-alkanediol having 10 or more carbon atoms and 1,2-hexanediol with no other components. In another of these examples, the wetting package may consist of the 1,2-alkanediol having 10 or more carbon atoms and a polymeric dispersant with no other components. In still another of these examples, the wetting package may consist of the 1,2-alkanediol having 10 or more carbon atoms, 1,2-hexanediol, and a polymeric dispersant with no other components. In still other examples, the wetting package includes a trio of 1,2-alkanediols, which includes the 1,2-alkanediol having 10 or more carbon atoms, a 1,2-alkanediol having 6 or fewer carbon atoms, and a 1,2-alkanediol having 7 or 8 carbon atoms. In some examples, the wetting package may lower the dynamic surface energy of the aqueous inkjet ink to about 25 dynes/cm or lower.

1,2-Alkanediols Having 10 or More Carbon Atoms

As mentioned above, the 1,2-alkanediol having 10 or more carbon atoms forms an oil/water emulsion with the water in the aqueous inkjet ink. In this emulsion, the 1,2-alkanediol acts as the oil component (i.e., the water-insoluble liquid) that is finely dispersed throughout the water. In the oil/water emulsion, the droplets of the 1,2-alkanediol have an average diameter of about 1 mm or smaller.

In some examples, the oil/water emulsion is a microemulsion. In these examples, the droplets of the 1,2-alkanediol have an average diameter of about 1 μm or smaller. In an example, the droplets of the 1,2-alkanediol have an average diameter of about 600 nm or smaller. In another example, the droplets of the 1,2-alkanediol have an average diameter ranging from about 100 nm to about 1 nm. In still another example, the droplets of the 1,2-alkanediol have an average diameter ranging from about 50 nm to about 10 nm. In yet another example, the droplets of the 1,2-alkanediol have an average diameter of about 35 nm. In yet another example, the droplets of the 1,2-alkanediol have an average diameter of about 20 nm. The average diameter may be based on a plurality of droplets. Laser light scattering, focused beam reflectance measurements (FBRM) or particle video microscopy (PVM) may be used to obtain droplet size distributions. The technique used to obtain droplet size distributions may depend, at least in part on the droplets. For example, the droplet size distribution of smaller droplets (e.g., having an average diameter ranging from about 50 nm to about 1 nm) may be obtained using laser light scattering.

In some examples, a 1,2-alkanediol having 6 or fewer carbon atoms (e.g., 1,2-hexanediol) and/or the polymeric dispersant may be used to achieve a desired droplet size of the 1,2-alkanediol having 10 or more carbon atoms. In other examples, a combination of a 1,2-alkanediol having 6 or fewer carbon atoms and a 1,2-alkanediol having 7 or 8 carbon atoms may be used to achieve a desired droplet size of the 1,2-alkanediol having 10 or more carbon atoms. In some examples, a surfactant may also help to achieve a desired droplet size of the 1,2-alkanediol having 10 or more carbon atoms. As such, it is to be understood that if too little of the 1,2-alkanediol with 6 or fewer carbon atoms, the polymeric dispersant, and/or the surfactant is used, the droplet size of the 1,2-alkanediol having 10 or more carbon atoms may be larger than desired. When the droplet size of the 1,2-alkanediol is too large, the emulsion formed may be unstable and the 1,2-alkanediol may separate from the water in the aqueous inkjet ink. It is also to be understood that if too much of the 1,2-alkanediol with 6 or fewer carbon atoms, the polymeric dispersant, and/or the surfactant is used, the droplet size of the 1,2-alkanediol having 10 or more carbon atoms may be smaller than desired. When the droplet size of the 1,2-alkanediol is too small, the 1,2-alkanediol may become ineffective at improving the wettability of the aqueous inkjet ink on low energy, hydrophobic media.

In the examples disclosed herein, the 1,2-alkanediol may be any 1,2-alkanediol that has 10 or more carbon atoms. In some examples of the aqueous inkjet ink, the 1,2-alkanediol having 10 or more carbon atoms is selected from the group consisting of 1,2-decanediol, 1,2-dodecanediol, 1,2-tetradecanediol, 1,2-hexadecanediol, and combinations thereof.

In some examples of the aqueous inkjet ink, the 1,2-alkanediol having 10 or more carbon atoms is present in the wetting package in an amount ranging from about 0.05 wt % active to about 2 wt % active, based on a total weight of the aqueous inkjet ink. In other examples, the 1,2-alkanediol having 10 or more carbon atoms is present in the wetting package in an amount ranging from about 0.1 wt % active to about 1 wt % active, based on the total weight of the aqueous inkjet ink. In still other examples, the 1,2-alkanediol is present in the wetting package in an amount ranging from about 0.1 wt % active to about 0.5 wt % active, based on the total weight of the aqueous inkjet ink. In still other examples, the 1,2-alkanediol is present in the wetting package in an amount ranging from about 0.1 wt % active to about 0.3 wt % active, based on the total weight of the aqueous inkjet ink.

In some examples, the amount of the 1,2-alkanediol may depend, at least in part, on the number of carbon atoms of the 1,2-alkanediol that is used in the aqueous inkjet ink. For example, if a 1,2-alkanediol with a longer chain (e.g., a 1,2-alkanediol having 14 or more carbon atoms) is used, the amount of the 1,2-alkanediol may be at the lower end of the given ranges (e.g., from about 0.1 wt % active to about 0.3 wt % active). If the inkjet ink includes more organic solvent (e.g., 50 wt % or more) or more aggressive organic solvents, then the amount of the 1,2-alkanediol may be increased.

1,2-Alkanediol Having 6 or Fewer Carbon Atoms

In some examples of the aqueous inkjet ink, the wetting package (and thus the ink) further includes a 1,2-alkanediol having 6 or fewer carbon atoms. As examples, the 1,2-alkanediol having 6 or fewer carbon atoms may be 1,2-hexanediol, 1,2-pentanediol, 1,2-butanediol, 1,2-propanediol, or derivatives thereof, or combinations thereof. In some examples of the aqueous inkjet ink, the wetting package further includes 1,2-hexanediol. As such, in these examples, the aqueous inkjet ink further includes 1,2-hexanediol.

In some examples of the aqueous inkjet ink, the 1,2-alkanediol having 6 or fewer carbon atoms is present in the wetting package in an amount ranging from about 1 wt % active to about 10 wt % active, based on a total weight of the aqueous inkjet ink. As such, in these examples, the 1,2-alkanediol having 6 or fewer carbon atoms is present in the aqueous inkjet ink in an amount ranging from about 1 wt % active to about 10 wt % active, based on a total weight of the aqueous inkjet ink.

The 1,2-alkanediol having 6 or fewer carbon atoms may be included to help solubilize or disperse the 1,2-alkanediol having 10 or more carbon atoms in the water of the aqueous inkjet ink. As such, 1,2-alkanediol having 6 or fewer carbon atoms may help stabilize the higher carbon 1,2-alkanediol in the aqueous inkjet ink so that a desired droplet size of the higher carbon 1,2-alkanediol may be achieved. The 1,2-alkanediol having 6 or fewer carbon atoms may be used i) alone as a dispersant or a solubilizer for the higher carbon 1,2-alkanediol, or ii) in combination with a 1,2-alkanediol having 7 or 8 carbon atom and/or iii) in combination with the polymeric dispersant. Thus, the amount of the 1,2-alkanediol having 6 or fewer carbon atoms included in the aqueous inkjet ink may depend, at least in part, on: (i) the higher carbon 1,2-alkanediol and its number of carbon atoms, (ii) the amount of the higher carbon 1,2-alkanediol used, (iii) whether a polymeric dispersant is used, and (iv) the amount of the polymeric dispersant used. For example, if a 1,2-alkanediol with a longer chain (e.g., a 1,2-alkanediol having 14 or more carbon atoms) is used in a higher amount (e.g., 0.3 wt % active), a higher amount (e.g., 10 wt % active) of the 1,2-hexanediol (or other 1,2-alkanediol having fewer carbon atoms) may be used. As another example, if a polymeric dispersant is used in a higher amount (e.g., about 5 wt % active), no 1,2-hexanediol (or other 1,2-alkanediol having fewer carbon atoms) or a lower amount (e.g., <4 wt % active) of the 1,2-hexanediol may be used.

Polymeric Dispersants

In some examples of the aqueous inkjet ink, the wetting package further includes a polymeric dispersant. As such, in these examples, the aqueous inkjet ink further includes a polymeric dispersant.

In some examples, the polymeric dispersant is a free polymeric dispersant. The phrase “free polymeric dispersant” means that the polymeric dispersant is not absorbed or attached to another ink component. For example, the free polymeric dispersant is not absorbed or attached to a pigment of the aqueous inkjet ink. Depending upon the colorant that is included in the ink, this free polymeric dispersant may be used in addition to another dispersant that is included to disperse the colorant.

In some examples of the aqueous inkjet ink, the free polymeric dispersant is present in the wetting package in an amount ranging from greater than 0 wt % active to about 10 wt % active, based on a total weight of the aqueous inkjet ink. As such, in these examples, the free polymeric dispersant is present in the aqueous inkjet ink in an amount ranging from greater than 0 wt % active to about 10 wt % active, based on a total weight of the aqueous inkjet ink. In other examples, the free polymeric dispersant is present in an amount ranging from about 1 wt % to about 5 wt %.

The polymeric dispersant may also be included to help solubilize or disperse the 1,2-alkanediol having 10 or more carbon atoms in the water of the aqueous inkjet ink. As such, the polymeric dispersant may help stabilize the higher carbon 1,2-alkanediol in the aqueous inkjet ink so that a desired droplet size of the 1,2-alkanediol may be achieved. Thus, the amount of the polymeric dispersant included in the aqueous inkjet ink may depend, at least in part, on: (i) the higher carbon 1,2-alkanediol and its number of carbon atoms, (ii) the amount of the higher carbon 1,2-alkanediol used, (iii) whether a 1,2-alkanediol with 6 or fewer carbon atoms is used, and (iv) the amount of the 1,2-alkanediol with 6 or fewer carbon atoms. For example, if a 1,2-alkanediol with a longer chain (e.g., a 1,2-alkanediol having 14 or more carbon atoms) is used in a higher amount (e.g., 0.3 wt % active), a higher amount (e.g., 5 wt % active) of the polymeric dispersant may be used. As another example, if 1,2-hexanediol (or other 1,2-alkanediol having fewer carbon atoms) is used in a higher amount (e.g., 10 wt % active), no polymeric dispersant or a lower amount (e.g., 1 wt % active) of the polymeric dispersant may be used.

Examples of the polymeric dispersant may be selected from the group consisting of a polyester-polyurethane dispersant, a polyether-polyurethane dispersant, a polycarbonate-polyurethane dispersant, and a latex dispersant. In other example, hybrids of any of these polymeric dispersants may be used.

In some examples of the aqueous inkjet ink, the free polymeric dispersant is a polyurethane-based dispersant, or a latex dispersant, or a styrene acrylate dispersant. The polyurethane-based dispersant may be a polyester-polyurethane dispersant, a polyether-polyurethane dispersant, a polycarbonate-polyurethane dispersant.

In an example, the aqueous inkjet ink includes the polyester-polyurethane dispersant. In an example, the polyester-polyurethane dispersant is a sulfonated polyester-polyurethane dispersant. The sulfonated polyester-polyurethane dispersant can include diaminesulfonate groups. In an example, the polyester-polyurethane dispersant is a sulfonated polyester-polyurethane dispersant, and is one of: i) an aliphatic compound including multiple saturated carbon chain portions ranging from C₄ to C₁₀ in length, and that is devoid of an aromatic moiety, or ii) an aromatic compound including an aromatic moiety and multiple saturated carbon chain portions ranging from C₄ to C₁₀ in length.

In one example, the sulfonated polyester-polyurethane dispersant can be anionic. In further detail, the sulfonated polyester-polyurethane dispersant can also be aliphatic, including saturated carbon chains as part of the polymer backbone or as a side-chain thereof, e.g., C₂ to C₁₀, C₃ to C₈, or C₃ to C₆ alkyl. These polyester-polyurethane dispersants can be described as “alkyl” or “aliphatic” because these carbon chains are saturated and because they are devoid of aromatic moieties. An example of an anionic aliphatic polyester-polyurethane dispersant that can be used is IMPRANIL® DLN-SD (CAS #375390-41-3; Mw 45,000 Mw; Acid Number 5.2; Tg-47° C.; Melting Point 175-200° C.) from Covestro. Example components used to prepare the IMPRANIL® DLN-SD or other similar anionic aliphatic polyester-polyurethane dispersants can include pentyl glycols (e.g., neopentyl glycol); C₄ to C₁₀ alkyldiol (e.g., hexane-1,6-diol); C₄ to C₁₀alkyl dicarboxylic acids (e.g., adipic acid); C₄ to C₁₀alkyl diisocyanates (e.g., hexamethylene diisocyanate (HDI)); diamine sulfonic acids (e.g., 1-[(2-aminoethyl)amino]-ethanesulfonic acid); etc.

Alternatively, the sulfonated polyester-polyurethane dispersant can be aromatic (or include an aromatic moiety) and can include aliphatic chains. An example of an aromatic polyester-polyurethane dispersant that can be used is DISPERCOLL® U42 (CAS #157352-07-3). Example components used to prepare the DISPERCOLL® U42 or other similar aromatic polyester-polyurethane dispersants can include aromatic dicarboxylic acids, e.g., phthalic acid; C₄ to C₁₀ alkyl dialcohols (e.g., hexane-1,6-diol); C₄ to C₁₀ alkyl diisocyanates (e.g., hexamethylene diisocyanate (HDI)); diamine sulfonic acids (e.g., 1-[(2-aminoethyl)amino]-ethanesulfonic acid); etc.

Other types of polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples.

The polyester-polyurethane dispersants disclosed herein may have a weight average molecular weight (Mw, g/mol) ranging from about 2,000 to about 50,000. As examples, the weight average molecular weight can range from about 5,000 to about 25,000, from about 10,000 to about 40,000, or from about 15,000 to about 30,000.

The polyester-polyurethane dispersants disclosed herein may have an acid number that ranges from about 1 mg/g KOH to about 50 mg/g KOH. For this dispersant, the term “acid number” refers to the mass of potassium hydroxide (KOH) in milligrams that is used to neutralize one gram of the sulfonated polyester-polyurethane dispersant. To determine this acid number, a known amount of a sample of the polyester-polyurethane dispersant may be dispersed in water and the aqueous dispersion may be titrated with a polyelectrolyte titrant of a known concentration. In this example, a current detector for colloidal charge measurement may be used. An example of a current detector is the Mütek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC).

As examples, the acid number of the sulfonated polyester-polyurethane dispersant can range from about 1 mg KOH/g to about 200 mg KOH/g, from about 2 mg KOH/g to about 100 mg KOH/g, or from about 3 mg KOH/g to about 50 mg KOH/g.

In an example of the aqueous inkjet ink, the polyester-polyurethane dispersant has a weight average molecular weight (g/mol) ranging from about 20,000 to about 300,000 and an acid number ranging from about 1 mg KOH/g to about 50 mg KOH/g.

The average particle size of the polyester-polyurethane dispersants disclosed herein may range from about 20 nm to about 500 nm. As examples, the sulfonated polyester-polyurethane dispersant can have an average particle size ranging from about 20 nm to about 500 nm, from about 50 nm to about 350 nm, or from about 100 nm to about 250 nm. The particle size of any solids herein, including the average particle size of the dispersant, can be determined using a NANOTRAC® Wave device, from Microtrac, e.g., NANOTRAC® Wave II or NANOTRAC® 150, etc, which measures particles size using dynamic light scattering. Average particle size can be determined using particle size distribution data generated by the NANOTRAC® Wave device.

Other examples of the aqueous inkjet ink include a polyether-polyurethane dispersant. Examples of polyether-polyurethanes that may be used include IMPRANIL® LP DSB 1069, IMPRANIL® DLE, IMPRANIL® DAH, or IMPRANIL® DL 1116 (Covestro (Germany)); or HYDRAN® WLS-201 or HYDRAN® WLS-201K (DIC Corp. (Japan)); or TAKELAC® W-6061T or TAKELAC® WS-6021 (Mitsui (Japan)).

Still other examples of the aqueous inkjet ink include a polycarbonate-polyurethane dispersant. Examples of polycarbonate-polyurethanes that may be used as the dispersant include IMPRANIL® DLC-F or IMPRANIL® DL 2077 (Covestro (Germany)); or HYDRAN® WLS-213 (DIC Corp. (Japan)); or TAKELAC® W-6110 (Mitsui (Japan)).

In still other examples, the aqueous inkjet ink includes a latex polymer dispersant. The term “latex polymer” generally refers to any dispersed polymer prepared from acrylate and/or methacrylate monomers, including an aromatic (meth)acrylate monomer that results in aromatic (meth)acrylate moieties as part of the latex. In an example, the latex polymer may be a copolymer of (meth)acrylate and styrene. In some examples, the latex particles can include a single heteropolymer that is homogenously copolymerized. In another example, a multi-phase latex polymer can be prepared that includes a first heteropolymer and a second heteropolymer. The two heteropolymers can be physically separated in the latex particles, such as in a core-shell configuration, a two-hemisphere configuration, smaller spheres of one phase distributed in a larger sphere of the other phase, interlocking strands of the two phases, and so on. If a two-phase polymer, the first heteropolymer phase can be polymerized from two or more aliphatic (meth)acrylate ester monomers or two or more aliphatic (meth)acrylamide monomers. The second heteropolymer phase can be polymerized from a cycloaliphatic monomer, such as a cycloaliphatic (meth)acrylate monomer or a cycloaliphatic (meth)acrylamide monomer. The first or second heteropolymer phase can include the aromatic (meth)acrylate monomer, e.g., phenyl, benzyl, naphthyl, etc. In one example, the aromatic (meth)acrylate monomer can be a phenoxylalkyl (meth)acrylate that forms a phenoxylalkyl (meth)acrylate moiety within the latex polymer, e.g. phenoxylether, phenoxylpropyl, etc. The second heteropolymer phase can have a higher T_{g} than the first heteropolymer phase in one example. The first heteropolymer composition may be considered a soft polymer composition and the second heteropolymers composition may be considered a hard polymer composition. If a two-phase heteropolymer, the first heteropolymer composition can be present in the latex polymer in an amount ranging from about 15 wt % to about 70 wt % of a total weight of the polymer particle, and the second heteropolymer composition can be present in an amount ranging from about 30 wt % to about 85 wt % of the total weight of the polymer particle. In other examples, the first heteropolymer composition can be present in an amount ranging from about 30 wt % to about 40 wt % of a total weight of the polymer particle, and the second heteropolymer composition can be present in an amount ranging from about 60 wt % to about 70 wt % of the total weight of the polymer particle.

In more general terms, whether there is a single heteropolymer phase, or there are multiple heteropolymer phases, heteropolymer(s) or copolymer(s) can include a number of various types of copolymerized monomers, including aliphatic(meth)acrylate ester monomers, such as linear or branched aliphatic (meth)acrylate monomers, cycloaliphatic (meth)acrylate ester monomers, or aromatic monomers. However, in accordance with the present disclosure, the aromatic monomer(s) selected for use can include an aromatic (meth)acrylate monomer. To be clear, reference to an “aromatic (meth)acrylate” does not include the copolymerization of two different monomers copolymerized together into a common polymer, e.g., styrene and methyl methacrylate. Rather, the term “aromatic (meth)acrylate” refers to a single aromatic monomer that is functionalized by an acrylate, methacrylate, acrylic acid, or methacrylic acid, etc.

The weight average molecular weight (g/mol) of the latex polymer can be from 50,000 to 500,000, for example. The acid number of the latex polymer can be from 2 mg KOH/g to 40 mg KOH/g, from 2 mg KOH/g to 30 mg KOH/g, or 3 mg KOH/g to 26 mg KOH/g, or 4 mg KOH/g to 20 mg KOH/g, for example.

The latex polymer can be in acid form, such as in the form of a polymer with (meth)acrylic acid surface groups, or may be in its salt form, such as in the form of a polymer with poly(meth)acrylate groups. The form (acid or salt) can be a function of pH. For example, if an acid were used during preparation of the latex polymer, pH modifications during preparation or subsequently when added to the ink composition can impact the nature of the moiety as well (acid form vs. salt form).

Any suitable styrene acrylate dispersant may be used. Some examples include those that are in the JONCRYL® family from BASF Corp.

The polymeric dispersant (prior to being incorporated into the aqueous inkjet ink) may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the dispersion become part of the aqueous liquid vehicle in the aqueous inkjet ink.

1,2-Alkanediol Having 7 or 8 Carbon Atoms

In some examples of the aqueous inkjet ink, the wetting package (and thus the ink) further includes a 1,2-alkanediol having 7 carbon atoms (heptanediol) or 8 carbon atoms (1,2-octanediol). These mid-range carbon chain length 1,2-alkanediols are believed to have a synergistic effect when combines with the 1,2-alkanediol having 10 or more carbon atoms and the 1,2-alkanediol having 6 or fewer carbon atoms, especially when printed on the wet low energy, hydrophobic media.

In one example, the 1,2-alkanediol having 10 or more carbon atoms is present in the wetting package in an amount ranging from about 0.05 wt % active to about 2 wt % active, based on a total weight of the aqueous inkjet ink; the 1,2-alkanediol having 6 or fewer carbon atoms is present in the wetting package in an amount ranging from about 1 wt % active to about 10 wt % active, based on a total weight of the aqueous inkjet ink; and the 1,2-alkanediol having 7 or 8 carbon atoms is present in the wetting package in an amount ranging from about 0.05 wt % active to about 4 wt % active, based on a total weight of the aqueous inkjet ink.

Colorants

The aqueous inkjet ink also includes a colorant. The colorant in the aqueous inkjet ink may be a pigment or a dye. Whether a pigment or a dye, the colorant can be any of a number of primary or secondary colors, or black or white. As specific examples, the colorant may be any color, including, as examples, a cyan pigment, a magenta pigment, a yellow pigment, a black pigment, a violet pigment, a green pigment, a brown pigment, an orange pigment, a purple pigment, a white pigment, or combinations thereof.

Dyes

In some examples, the colorant may be a dye. As used herein, “dye” refers to compounds or molecules that absorb electromagnetic radiation or certain wavelengths thereof. Dyes can impart a visible color to the aqueous inkjet ink if the dyes absorb wavelengths in the visible spectrum.

The dye (prior to being incorporated into the ink formulation), may be dispersed in water alone or in combination with an additional water soluble or water miscible co-solvent, such as those described for the dispersant. It is to be understood however, that the liquid components of the dye dispersion become part of the aqueous vehicle in the aqueous inkjet ink.

In some examples, the dye may be present in an amount ranging from about 0.5 wt % active to about 15 wt % active based on a total weight of the aqueous inkjet ink. In one example, the dye may be present in an amount ranging from about 1 wt % active to about 10 wt % active. In another example, the dye may be present in an amount ranging from about 5 wt % active to about 10 wt % active.

The dye can be nonionic, cationic, anionic, or a mixture of nonionic, cationic, and/or anionic dyes. The dye can be a hydrophilic anionic dye, a direct dye, a reactive dye, a polymer dye or an oil soluble dye. Specific examples of dyes that may be used include Sulforhodamine B, Acid Blue 113, Acid Blue 29, Acid Red 4, Rose Bengal, Acid Yellow 17, Acid Yellow 29, Acid Yellow 42, Acridine Yellow G, Acid Yellow 23, Acid Blue 9, Nitro Blue Tetrazolium Chloride Monohydrate or Nitro BT, Rhodamine 6G, Rhodamine 123, Rhodamine B, Rhodamine B Isocyanate, Safranine O, Azure B, and Azure B Eosinate, which are available from Sigma-Aldrich Chemical Company (St. Louis, Mo.). Examples of anionic, water-soluble dyes include Direct Yellow 132, Direct Blue 199, Magenta 377 (available from Ilford AG, Switzerland), alone or together with Acid Red 52. Examples of water-insoluble dyes include azo, xanthene, methine, polymethine, and anthraquinone dyes. Specific examples of water-insoluble dyes include ORASOL® Blue GN, ORASOL® Pink, and ORASOL® Yellow dyes available from BASF Corp. Black dyes may include Direct Black 154, Direct Black 168, Fast Black 2, Direct Black 171, Direct Black 19, Acid Black 1, Acid Black 191, Mobay Black SP, and Acid Black 2.

Pigments

In other examples, the colorant may be a pigment. The pigment may be incorporated into the aqueous inkjet ink as a pigment dispersion. The pigment dispersion may include a pigment and a separate dispersant (which is in addition to the polymeric dispersant described herein), or may include a self-dispersed pigment.

For the pigment dispersions disclosed herein, it is to be understood that the pigment and separate dispersant or the self-dispersed pigment (prior to being incorporated into the ink formulation), may be dispersed in water alone or in combination with an additional water soluble or water miscible co-solvent, such as those described for the dispersant. It is to be understood however, that the liquid components of the pigment dispersion become part of the aqueous vehicle in the aqueous inkjet ink.

In some examples of the aqueous inkjet ink, the colorant is a pigment present in an amount ranging from about 1.5 wt % active to about 6 wt % active, based on a total weight of the aqueous inkjet ink. In one of these examples, the pigment is present in an amount of about 4 wt % active. In another of these examples, the pigment is present in an amount of about 2 wt % active. In these examples, the pigment may be in the form of a dispersion that includes the pigment and separate dispersant, or that includes the self-dispersed pigment. In these examples, the loadings refer to active pigment solids, and no other components that may be present in the pigment dispersion. Also in these examples, the lower amount of the pigment may contribute to the improved ability of the aqueous inkjet ink to wet low energy, hydrophobic media.

Pigments and Separate Dispersants

Examples of the aqueous inkjet ink may include a pigment that is not self-dispersing and a separate dispersant. Examples of these pigments, as well as suitable dispersants for these pigments will now be described.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50. Any quinacridone pigment or a co-crystal of quinacridone pigments may be used for magenta inks.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation, Boston, Mass., (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, C.I. Pigment Orange 71, and C.I. Pigment Orange 73.

The average particle size of the pigments may range anywhere from about 20 nm to about 200 nm. In an example, the average particle size ranges from about 80 nm to about 150 nm.

Any of the pigments mentioned herein can be dispersed by a separate dispersant, such as a styrene (meth)acrylate dispersant, or another dispersant suitable for keeping the pigment suspended in the aqueous ink vehicle. For example, the dispersant can be any dispersing (meth)acrylate polymer, or other type of polymer, such as maleic polymer or a dispersant with aromatic groups and a poly(ethylene oxide) chain.

In one example, (meth)acrylate polymer can be a styrene-acrylic type dispersant polymer, as it can promote π-stacking between the aromatic ring of the dispersant and various types of pigments, such as copper phthalocyanine pigments, for example. In one example, the styrene-acrylic dispersant can have a weight average molecular weight (M_{w}) ranging from about 4,000 to about 30,000. In another example, the styrene-acrylic dispersant can have a weight average molecular weight ranging from about 8,000 to about 28,000, from about 12,000 to about 25,000, from about 15,000 to about 25,000, from about 15,000 to about 20,000, or about 17,000. Regarding the acid number, the styrene-acrylic dispersant can have an acid number from 100 to 350, from 120 to 350, from 150 to 250, from 155 to 185, or about 172, for example. Example commercially available styrene-acrylic dispersants can include JONCRYL® 671, JONCRYL® 71, JONCRYL® 96, JONCRYL® 680, JONCRYL® 683, JONCRYL® 678, JONCRYL® 690, JONCRYL® 296, JONCRYL® 696 or JONCRYL® ECO 675 (all available from BASF Corp.).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. For examples, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

The following are some example pigment and separate dispersant combinations: a carbon black pigment with a styrene acrylic dispersant; PB 15:3 (cyan pigment) with a styrene acrylic dispersant; PR122 (magenta) or a co-crystal of PR122 and PV19 (magenta) with a styrene acrylic dispersant; or PY74 (yellow) or PY155 (yellow) with a styrene acrylic dispersant.

In an example, the pigment is present in the aqueous inkjet ink in an amount ranging from about 1 wt % active to about 6 wt % active of the total weight of the aqueous inkjet ink. In another example, the pigment is present in the aqueous inkjet ink in an amount ranging from about 2 wt % active to about 6 wt % active of the total weight of the aqueous inkjet ink. When the separate dispersant is used, the separate dispersant may be present in an amount ranging from about 0.05 wt % active to about 6 wt % active of the total weight of the aqueous inkjet ink. In some examples, the ratio of pigment to separate dispersant may range from 0.1 (1:10) to 1 (1:1).

Self-Dispersed Pigments

In other examples, the aqueous inkjet ink includes a self-dispersed pigment, which includes a pigment and an organic group attached thereto.

Any of the pigments set forth herein may be used, such as carbon, phthalocyanine, quinacridone, azo, or any other type of organic pigment, as long as at least one organic group that is capable of dispersing the pigment is attached to the pigment.

The organic group that is attached to the pigment includes at least one aromatic group, an alkyl (e.g., C₁ to C₂₀), and an ionic or ionizable group.

The aromatic group may be an unsaturated cyclic hydrocarbon containing one or more rings and may be substituted or unsubstituted, for example with alkyl groups. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like).

The alkyl may be branched or unbranched, substituted or unsubstituted.

The ionic or ionizable group may be at least one phosphorus-containing group, at least one sulfur-containing group, or at least one carboxylic acid group.

In an example, the at least one phosphorus-containing group has at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof. By “partial ester thereof”, it is meant that the phosphorus-containing group may be a partial phosphonic acid ester group having the formula —PO₃RH, or a salt thereof, wherein R is an aryl, alkaryl, aralkyl, or alkyl group. By “salts thereof”, it is meant that the phosphorus-containing group may be in a partially or fully ionized form having a cationic counterion.

When the organic group includes at least two phosphonic acid groups or salts thereof, either or both of the phosphonic acid groups may be a partial phosphonic ester group. Also, one of the phosphonic acid groups may be a phosphonic acid ester having the formula —PO₃R₂, while the other phosphonic acid group may be a partial phosphonic ester group, a phosphonic acid group, or a salt thereof. In some instances, it may be desirable that at least one of the phosphonic acid groups is either a phosphonic acid, a partial ester thereof, or salts thereof. When the organic group includes at least two phosphonic acid groups, either or both of the phosphonic acid groups may be in either a partially or fully ionized form. In these examples, either or both may of the phosphonic acid groups have the formula —PO₃H₂, —PO₃H⁻M⁺ (monobasic salt), or —PO₃⁻² M⁺² (dibasic salt), wherein M⁺ is a cation such as Na⁺, K⁺, Li⁺, or NR₄⁺, wherein R, which can be the same or different, represents hydrogen or an organic group such as a substituted or unsubstituted aryl and/or alkyl group.

As other examples, the organic group may include at least one geminal bisphosphonic acid group, partial esters thereof, or salts thereof. By “geminal”, it is meant that the at least two phosphonic acid groups, partial esters thereof, or salts thereof are directly bonded to the same carbon atom. Such a group may also be referred to as a 1,1-diphosphonic acid group, partial ester thereof, or salt thereof.

An example of a geminal bisphosphonic acid group may have the formula —CQ(PO₃H₂)₂, or may be partial esters thereof or salts thereof. Q is bonded to the geminal position and may be H, R, OR, SR, or NR₂ wherein R, which can be the same or different when multiple are present, is selected from H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. For examples, Q may be H, R, OR, SR, or NR₂, wherein R, which can be the same or different when multiple are present, is selected from H, a C₁-C₆ alkyl group, or an aryl group. As specific examples, Q is H, OH, or NH₂. Another example of a geminal bisphosphonic acid group may have the formula —(CH₂)ₙCQ(PO₃H₂)₂, or may be partial esters thereof or salts thereof, wherein Q is as described above and n is 0 to 9, such as 1 to 9. In some specific examples, n is 0 to 3, such as 1 to 3, or n is either 0 or 1.

Still another example of a geminal bisphosphonic acid group may have the formula —X—(CH₂)ₙCQ(PO₃H₂)₂, or may be partial esters thereof or salts thereof, wherein Q and n are as described above and X is an arylene, heteroarylene, alkylene, vinylidene, alkarylene, aralkylene, cyclic, or heterocyclic group. In specific examples, X is an arylene group, such as a phenylene, naphthalene, or biphenylene group, which may be further substituted with any group, such as one or more alkyl groups or aryl groups. When X is an alkylene group, examples include substituted or unsubstituted alkylene groups, which may be branched or unbranched and can be substituted with one or more groups, such as aromatic groups. Examples of X include C₁-C₁₂ groups like methylene, ethylene, propylene, or butylene. X may be directly attached to the pigment, meaning there are no additional atoms or groups from the attached organic group between the pigment and X. X may also be further substituted with one or more functional groups. Examples of functional groups include R′, OR′, COR′, COOR′, OCOR′, carboxylates, halogens, CN, NR′₂, SO₃H, sulfonates, sulfates, NR′(COR′), CONR′₂, imides, NO₂, phosphates, phosphonates, N═NR′, SOR′, NR′SO₂R′, and SO₂NR′₂, wherein R′, which can be the same or different when multiple are present, is independently selected from hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

Yet another example of a geminal bisphosphonic acid group may have the formula —X—Sp-(CH₂)ₙCQ(PO₃H₂)₂, or may be partial esters thereof or salt thereof, wherein X, Q, and n are as described above. “Sp” is a spacer group, which, as used herein, is a link between two groups. Sp can be a bond or a chemical group. Examples of chemical groups include, but are not limited to, —CO₂—, —O₂C—, —CO—, —OSO₂—, —SO₃—, —SO₂—, —SO₂C₂H₄O—, —SO₂C₂H₄S—, —SO₂C₂H₄NR″—, —O—, —S—, —NR″—, —NR″CO—, —CONR″—, —NR″CO₂—, —O₂CNR″—, —NR″CONR″—, —N(COR″)CO—, —CON(COR″)—, —NR″COCH(CH₂CO₂R″)— and cyclic imides therefrom, —NR″COCH₂CH(CO₂R″)— and cyclic imides therefrom, —CH(CH₂CO₂R″)CONR″— and cyclic imides therefrom, —CH(CO₂R″)CH₂CONR″ and cyclic imides therefrom (including phthalimide and maleimides of these), sulfonamide groups (including —SO₂NR″— and —NR″SO₂— groups), arylene groups, alkylene groups and the like. R″, which can be the same or different when multiple are included, represents H or an organic group such as a substituted or unsubstituted aryl or alkyl group. In the example formula —X—Sp-(CH₂),CQ(PO₃H₂)₂, the two phosphonic acid groups or partial esters or salts thereof are bonded to X through the spacer group Sp. Sp may be —CO₂—, —O₂C—, —O—, —NR″—, —NR″CO—, or —CONR″—, —SO₂NR″—, —SO₂CH₂CH₂NR″—, —SO₂CH₂CH₂O—, or —SO₂CH₂CH₂S— wherein R″ is H or a C₁-C₆ alkyl group.

Still a further example of a geminal bisphosphonic acid group may have the formula —N—[(CH₂)ₘ(PO₃H₂)]₂, partial esters thereof, or salts thereof, wherein m, which can be the same or different, is 1 to 9. In specific examples, m is 1 to 3, or 1 or 2. As another example, the organic group may include at least one group having the formula —(CH₂)n-N—[(CH₂)ₘ(PO₃H₂)]₂, partial esters thereof, or salts thereof, wherein n is 0 to 9, such as 1 to 9, or 0 to 3, such as 1 to 3, and m is as defined above. Also, the organic group may include at least one group having the formula —X—(CH₂)ₙ—N—[(CH₂)ₘ(PO₃H₂)]₂, partial esters thereof, or salts thereof, wherein X, m, and n are as described above, and, in an example, X is an arylene group. Still further, the organic group may include at least one group having the formula —X—Sp-(CH₂)ₙ—N—[(CH₂)ₘ(PO₃H₂)]₂, partial esters thereof, or salts thereof, wherein X, m, n, and Sp are as described above.

Yet a further example of a geminal bisphosphonic acid group may have the formula —CR═C(PO₃H₂)₂, partial esters thereof, or salts thereof. In this example, R can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In an example, R is H, a C₁-C₆ alkyl group, or an aryl group.

The organic group may also include more than two phosphonic acid groups, partial esters thereof, or salts thereof, and may, for example include more than one type of group (such as two or more) in which each type of group includes at least two phosphonic acid groups, partial esters thereof, or salts thereof. For example, the organic group may include a group having the formula —X—[CQ(PO₃H₂)₂]p, partial esters thereof, or salts thereof. In this example, X and Q are as described above. In this formula, p is 1 to 4, e.g., 2.

In addition, the organic group may include at least one vicinal bisphosphonic acid group, partial ester thereof, or salts thereof, meaning that these groups are adjacent to each other. Thus, the organic group may include two phosphonic acid groups, partial esters thereof, or salts thereof bonded to adjacent or neighboring carbon atoms. Such groups are also sometimes referred to as 1,2-diphosphonic acid groups, partial esters thereof, or salts thereof. The organic group including the two phosphonic acid groups, partial esters thereof, or salts thereof may be an aromatic group or an alkyl group, and therefore the vicinal bisphosphonic acid group may be a vicinal alkyl or a vicinal aryl diphosphonic acid group, partial ester thereof, or salts thereof. For example, the organic group may be a group having the formula —C₆H₃—(PO₃H₂)₂, partial esters thereof, or salts thereof, wherein the acid, ester, or salt groups are in positions ortho to each other.

In other examples, the ionic or ionizable group (of the organic group attached to the pigment) is a sulfur-containing group. The at least one sulfur-containing group has at least one S═O bond, such as a sulfinic acid group or a sulfonic acid group. Salts of sulfinic or sulfonic acids may also be used, such as —SO₃⁻X⁺, where X is a cation, such as Na⁺, H⁺, K⁺, NH₄⁺, Li⁺, Ca²⁺, Mg⁺, etc.

When the ionic or ionizable group is a carboxylic acid group, the group may be COOH or a salt thereof, such as —COO⁻X⁺, —(COO⁻X⁺)₂, or —(COO⁻X⁺)₃.

Examples of the self-dispersed pigments are commercially available as dispersions. Suitable commercially available self-dispersed pigment dispersions include those of the CAB-O-JET® 200 Series, manufactured by Cabot Corporation. Some specific examples include CAB-O-JET® 200 (black pigment), CAB-O-JET® 250C (cyan pigment), CAB-O-JET® 260M or 265M (magenta pigment) and CAB-O-JET® 270 (yellow pigment)). Other suitable commercially available self-dispersed pigment dispersions include those of the CAB-O-JET® 400 Series, manufactured by Cabot Corporation. Some specific examples include CAB-O-JET® 400 (black pigment), CAB-O-JET® 450C (cyan pigment), CAB-O-JET® 465M (magenta pigment) and CAB-O-JET® 470Y (yellow pigment)). Still other suitable commercially available self-dispersed pigment dispersions include those of the CAB-O-JET® 300 Series, manufactured by Cabot Corporation. Some specific examples include CAB-O-JET® 300 (black pigment) and CAB-O-JET® 352K (black pigment).

The self-dispersed pigment may be present in an amount ranging from about 1 wt % active to about 6 wt % active based on a total weight of the aqueous inkjet ink. In an example, the dispersed pigment is present in an amount ranging from about 2 wt % active to about 5 wt % active based on a total weight of the aqueous inkjet ink. In another example, the self-dispersed pigment is present in an amount of about 3 wt % based on the total weight of the aqueous inkjet ink. In still another example, the self-dispersed pigment is present in an amount of about 5 wt % active based on the total weight of the aqueous inkjet ink.

Aqueous Vehicles

In addition to the wetting package and the colorant, the aqueous inkjet ink includes a co-solvent and a balance of water. In some examples, the aqueous inkjet ink also includes an additive selected from the group consisting of a surfactant, a saccharide, an anti-kogation agent, an anti-decel agent, a biocide, a chelating agent, a rheological modifier, a pH adjuster, and a combination thereof. The co-solvent, the water, and the additive (when included) may be part of an aqueous vehicle.

As used herein, the term “aqueous vehicle” may refer to the liquid with which the wetting package and the colorant are mixed to form the aqueous inkjet ink. A wide variety of vehicles may be used with the aqueous inkjet ink of the present disclosure. The vehicle may include, in addition to the co-solvent and water, a saccharide, an anti-kogation agent, an anti-decel agent, a surfactant, a biocide, a chelating agent, a rheological modifier, a pH adjuster, or combinations thereof. In an example, the vehicle consists of the co-solvent and water, and the saccharide, the anti-kogation agent, the anti-decel agent, the surfactant, the biocide, the chelating agent, the rheological modifier, the pH adjuster, or a combination thereof. In another example, the vehicle consists of the co-solvent and water, and the saccharide, the surfactant, the pH adjuster, or a combination thereof.

The vehicle may include co-solvent(s). The co-solvent(s) may be present in an amount ranging from about 4 wt % to about 30 wt % (based on the total weight of the aqueous inkjet ink). It may be desirable to select a co-solvent or combination of co-solvents that will not deleteriously affect the effect of the wetting package disclosed herein.

Examples of co-solvents include alcohols, aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl alcohol, butyl alcohol, and benzyl alcohol. Other specific examples include tripropylene glycol methyl ether, tripropylene glycol n-butyl ether, 2-ethyl-2-(hydroxymethyl)-1,3-propane diol (EPHD), 2-methyl-1,3-propanediol, dimethyl sulfoxide, and sulfolane.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

The co-solvent may also include a hydantoin. An example of a hydantoin is di(2-hydroxyethyl)-5,5-dimethylhydantoin.

In one specific example, the co-solvent is selected from the group consisting of lactams, formamides, acetamides, and long chain alcohols.

In some examples, the aqueous inkjet ink further comprises a saccharide. The saccharide may be present in the aqueous inkjet ink in an amount ranging from about 1 wt % to about 15 wt %, based on the total weight of the aqueous inkjet ink. In another example, the saccharide may be present in the aqueous inkjet ink in an amount ranging from about 1 wt % to about 10 wt %, based on the total weight of the aqueous inkjet ink. In an example, the saccharide is present in the aqueous inkjet ink in an amount of about 5 wt %, based on the total weight of the aqueous inkjet ink. Examples of the saccharide include glucose, mannose, fructose, ribose, xylose, arabinose, galactose, glucitol, sorbitol, maltose, cellobiose, lactose, sucrose, trehalose, maltotriose, and raffinose. In one example, the saccharide is sorbitol.

An anti-kogation agent may also be included in the vehicle of a thermal inkjet formulation. Kogation refers to the deposit of dried printing liquid (e.g., dried aqueous inkjet ink) on a heating element of a thermal inkjet printhead. Anti-kogation agent(s) is/are included to assist in preventing the buildup of kogation. In some examples, the anti-kogation agent may improve the jettability of the aqueous inkjet ink. The anti-kogation agent may be present in the aqueous inkjet ink in an amount ranging from about 0.1 wt % active to about 1.5 wt % active, based on the total weight of the aqueous inkjet ink. In an example, the anti-kogation agent is present in the aqueous inkjet ink in an amount of about 0.5 wt % active, based on the total weight of the aqueous inkjet ink.

Examples of suitable anti-kogation agents include oleth-3-phosphate (commercially available as CRODAFOS™ O3A or CRODAFOS™ N-3A) or dextran 500k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

The vehicle may include anti-decel agent(s). Decel refers to a decrease in drop velocity over time with continuous firing. Anti-decel agent(s) is/are included to assist in preventing decel. In some examples, the anti-decel agent may improve the jettability of the aqueous inkjet ink. The anti-decel agent may be present in an amount ranging from about 0.2 wt % active to about 5 wt % active (based on the total weight of the aqueous inkjet ink). In an example, the anti-decel agent is present in the aqueous inkjet ink in an amount of about 1 wt % active, based on the total weight of the aqueous inkjet ink.

An example of a suitable anti-decel agent is ethoxylated glycerin having the following formula:

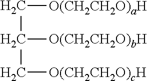

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

The vehicle of the aqueous inkjet ink may also include surfactant(s). In any of the examples disclosed herein, the surfactant may be present in an amount ranging from about 0.01 wt % active to about 5 wt % active (based on the total weight of the aqueous inkjet ink). In an example, the surfactant is present in the aqueous inkjet ink in an amount ranging from about 0.05 wt % active to about 3 wt % active, based on the total weight of the aqueous inkjet ink.

The surfactant may include anionic and/or non-ionic surfactants. Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsulfonate, and dibutylphenylphenol disulfonate. Another example of the anionic surfactant is sodium dodecyl sulfate.

Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a siloxane surfactant or a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the vehicle may include a silicone-free alkoxylated alcohol surfactant such as, for example, TEGO® Wet 510 (EvonikTegoChemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.).

In one specific example, the aqueous inkjet ink further comprises a surfactant selected from the group consisting of an anionic surfactant, a fluorine surfactant, a biosurfactant, a polyoxyethylene alkyl ether, a polyoxyethylene alkyl phenyl ether, a polyoxyethylene fatty acid ester, a sorbitan fatty acid ester, a polyoxyethylene sorbitan fatty acid ester, a polyoxyethylene sorbitol fatty acid ester, a glycerin fatty acid ester, a polyoxyethylene glycerin fatty acid ester, a polyglycerin fatty acid ester, a polyoxyethylene alkylamine, a polyoxyethylene fatty acid amide, an alkylalkanolamide, a polyethylene glycol polypropylene glycol block copolymer, an acetylene glycol, and a polyoxyethylene adduct of acetylene glycol.

The chelating agent is another example of an additive that may be included in the aqueous vehicle. When included, the chelating agent is present in an amount greater than 0 wt % active and less than or equal to 0.5 wt % active based on the total weight of the aqueous inkjet ink. In an example, the chelating agent is present in an amount ranging from about 0.05 wt % active to about 0.2 wt % active based on the total weight of the aqueous inkjet ink.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

In one specific example, the chelating agent is selected from the group consisting of 4,5-dihydroxy-1,3-benzenedisulfonic acid disodium salt monohydrate; ethylenediaminetetraacetic acid; and hexamethylenediamine tetra(methylene phosphonic acid), potassium salt.

The vehicle may also include biocide(s) (i.e., antimicrobial agents). In an example, the total amount of biocide(s) in the aqueous inkjet ink ranges from about 0.1 wt % active to about 0.25 wt % active (based on the total weight of the aqueous inkjet ink). In another example, the total amount of biocide(s) in the aqueous inkjet ink is about 0.23 wt % active (based on the total weight of the aqueous inkjet ink).

Examples of suitable biocides include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

In some examples, the aqueous vehicle may include a rheological modifier, which may aid in controlling the spreading of the aqueous inkjet ink. In an example, the total amount of rheology modifier(s) in the aqueous inkjet ink ranges from about 0.5 wt % active to about 2 wt % active (based on the total weight of the aqueous inkjet ink).

Some examples of suitable rheology modifiers include polycarboxylate-based compounds, polycarboxylate-based alkaline swellable emulsions, and/or their derivatives. Some specific examples include: CARTACOAT® RM 12, commercially available from Clariant International Ltd. (Muttenz, Switzerland); a hydrophobically modified anionic thickener, commercially available under the tradename Acrysol TT-615 from Dow Chemical Company (Midland, Mich.); and an aqueous, anionic dispersion of an ethyl acrylate-carboxylic acid copolymer that is a synthetic thickener with high water retention, commercially available under the tradename Sterocoll® FS from BASF (Charlotte, N.C.).

The vehicle may also include a pH adjuster. A pH adjuster may be included in the aqueous inkjet ink to achieve a desired pH (e.g., a pH of about 8.5) and/or to counteract any slight pH drop that may occur over time. In an example, the total amount of pH adjuster(s) in the aqueous inkjet ink ranges from greater than 0 wt % to about 0.1 wt % (based on the total weight of the aqueous inkjet ink). In another example, the total amount of pH adjuster(s) in the aqueous inkjet ink is about 0.03 wt % (based on the total weight of the aqueous inkjet ink).

Examples of suitable pH adjusters include metal hydroxide bases, such as potassium hydroxide (KOH), sodium hydroxide (NaOH), etc. In an example, the metal hydroxide base may be added to the aqueous inkjet ink in an aqueous solution. In another example, the metal hydroxide base may be added to the aqueous inkjet ink in an aqueous solution including 5 wt % of the metal hydroxide base (e.g., a 5 wt % potassium hydroxide aqueous solution).

Suitable pH ranges for examples of the aqueous inkjet ink can be from pH 7 to pH 11, from pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8.

The balance of the aqueous inkjet ink is water. In an example, deionized water may be used. In examples where the aqueous inkjet ink is a thermal inkjet ink, the liquid vehicle is an aqueous based vehicle including at least 70% by weight of water. In examples where the aqueous inkjet ink is a piezoelectric inkjet ink, the liquid vehicle is a solvent based vehicle including at least 50% by weight of the co-solvent.

Substrates

The aqueous inkjet ink can be applied on a broad selection of substrates. In some examples, the substrate may be a low energy, hydrophobic substrate. The term “low energy” refers to the surface energy of the medium, and may be measured by the contact angle a liquid (such as water) has on the surface. The larger the contact angle, the more hydrophobic the surface. The contact angle and the surface energy may vary depending upon the medium. As examples, the contact angle of water on polyvinyl chloride is about 85.6, and on polypropylene is about 1.2, and on polyethylene is about 96. In one example disclosed herein, the substrate is selected from the group consisting of a vinyl substrate, a polyvinylchloride substrate, a stainless steel substrate, a silicon substrate, an acrylic substrate, an acrylate substrate, a polyethylene substrate, and a non-treated polypropylene substrate.

Printing Methods

FIG. 1 depicts an example of the printing method 100. As shown in FIG. 1, an example the printing method 100 comprises: ejecting an aqueous inkjet ink on a substrate, wherein: the aqueous inkjet ink includes: a 1,2-alkanediol having 10 or more carbon atoms; a polymeric dispersant; a co-solvent; a colorant; and a balance of water; and the substrate is selected from the group consisting of a vinyl substrate, a polyvinylchloride substrate, a stainless steel substrate, a silicon substrate, an acrylic substrate, an acrylate substrate, a polyethylene substrate, and a non-treated polypropylene substrate (reference numeral 102).

It is to be understood that any example of the aqueous inkjet ink disclosed herein may be used in the examples of the method 100. In one specific example, the aqueous inkjet ink includes: a 1,2-alkanediol having 10 or more carbon atoms; a polymeric dispersant; a co-solvent; a colorant; and a balance of water. In another example, the dispersant is a free polymeric dispersant.

It is also to be understood that any example of the substrates may be used in the examples of the method 100. In one specific example, the substrate is selected from the group consisting of a vinyl substrate, a polyvinylchloride substrate, a stainless steel substrate, a silicon substrate, an acrylic substrate, an acrylate substrate, a polyethylene substrate, and a non-treated polypropylene substrate.

In some examples, multiple aqueous inkjet inks may be ejected onto the substrate. In these examples, each of the aqueous inkjet inks may include an example of the wetting package, a colorant, and the aqueous vehicle. However, each of the aqueous inkjet inks may include a different colorant so that a different color (e.g., cyan, magenta, yellow, black, violet, green, brown, orange, purple, white, etc.) is generated by each of the aqueous inkjet inks. As an example, a combination of two or more aqueous inkjet inks selected from the group consisting of a cyan ink, a magenta ink, a yellow ink, and a black ink may be ejected onto the substrate.

In other examples, a single aqueous inkjet ink may be ejected onto the substrate.

The aqueous inkjet ink(s) may be ejected onto the substrate using any suitable applicator, such as a thermal inkjet printhead, a piezoelectric printhead, a continuous inkjet printhead, etc. The applicator may eject the aqueous inkjet ink(s) in a single pass or in multiple passes. As an example of single pass printing, the cartridge(s) of an inkjet printer deposit the desired amount of the aqueous inkjet ink(s) during the same pass of the cartridge(s) across the substrate. In other examples, the cartridge(s) of an inkjet printer deposit the desired amount of the aqueous inkjet ink(s) over several passes of the cartridge(s) across the substrate.

When the aqueous inkjet ink(s) is/are ejected on the substrate, the aqueous inkjet ink(s) sufficiently wet(s) the substrate. In some examples, coalescence and mottling of the aqueous inkjet ink(s) on the substrate may be reduced or eliminated (as compared to the coalescence and mottling of aqueous ink(s) (including the same components as the aqueous inkjet ink(s) except for the wetting package) on the substrate). In some examples, the uniformity and efficiency of the aqueous inkjet ink(s) on the substrate may be improved (as compared to the coalescence and mottling of aqueous ink(s) (including the same components as the aqueous inkjet ink(s) except for the wetting package) on the substrate).

To further illustrate the present disclosure, examples are given herein. It is to be understood that these examples are provided for illustrative purposes and are not to be construed as limiting the scope of the present disclosure.

### EXAMPLES

### Example 1

Six examples of the aqueous inkjet ink disclosed herein were prepared (referred to as “Ex. Ink 1,” “Ex. Ink 2,” “Ex. Ink 3,” “Ex. Ink 4,” “Ex. Ink 5,” and “Ex. Ink 6”). The example wetting package included in each of the example aqueous inkjet inks included 1,2-decanediol as the 1,2-alkanediol having 10 or more carbon atoms.

A comparative example of the aqueous inkjet ink was also prepared (referred to as “Comp. Ink 1”). The comparative aqueous inkjet ink did not include any 1,2-alkanediol having 10 or more carbon atoms.

The general formulation of each of these aqueous inkjet inks (example and comparative) is shown in Table 1, with the wt % active of each component that was used. For example, the weight percentage of the pigment dispersion represents the total pigment solids (i.e., wt % active pigment) present in the final ink formulations. In other words, the amount of the pigment dispersion added to the ink compositions was enough to achieve a pigment solids level equal to the given weight percent. Similarly, the weight percentage of the dispersant represents the total dispersant solids (i.e., wt % active dispersant) present in the final ink formulations. Additionally, a 5 wt % potassium hydroxide aqueous solution was added to each of the ink compositions until a pH of about 8.5 was achieved.

TABLE 1

| | | Comp. | | | | | | |
|---|---|---|---|---|---|---|---|---|
| | Specific | lnk 1 | Ex lnk 1 | Ex. lnk 2 | Ex. lnk 3 | Ex. lnk 4 | Ex. lnk 5 | Ex lnk 6 |
| Ingredient | Component | (wt %) | (wt %) | (wt %) | (wt %) | (wt %) | (wt %) | (wt %) |
| 1,2-alkanediol | 1,2-decanediol | --- | 0.1 | 0.2 | 0.3 | 0.5 | 0.75 | 1 |
| having 10 or | | | | | | | | |
| more carbon | | | | | | | | |
| atoms | | | | | | | | |
| Colorant | CAB-O-JET ® 465 M | 4.5 | 4.5 | 4.5 | 4.5 | 4.5 | 4.5 | 4.5 |
| | Dye | 0.4 | 0.4 | 0.4 | 0.4 | 0.4 | 0.4 | 0.4 |
| Co-solvent | 2-pyrrolidone | 10 | 10 | 10 | 10 | 10 | 10 | 10 |
| | 1-(2-hydroxyethyl)- | 5 | 5 | 5 | 5 | 5 | 5 | 5 |
| | 2-pyrrolidone | | | | | | | |
| Saccharide | Sorbitol | 10 | 10 | 10 | 10 | 10 | 10 | 10 |
| Surfactant | SURFADONE ® | 0.05 | 0.05 | 0.05 | 0.05 | 0.05 | 0.05 | 0.05 |
| | LP100 | | | | | | | |
| Acid | Organic Acid | 0.2 | 0.2 | 0.2 | 0.2 | 0.2 | 0.2 | 0.2 |
| Silica | Silica | 4 | 4 | 4 | 4 | 4 | 4 | 4 |
| Water | Deionized water | Balance | Balance | Balance | Balance | Balance | Balance | Balance |

Six additional examples of the aqueous inkjet ink disclosed herein were prepared (referred to as “Ex. Ink 7,” “Ex. Ink 8,” “Ex. Ink 9,” “Ex. Ink 10,” “Ex. Ink 11,” and “Ex. Ink 12”). The example wetting package included in each of the example aqueous inkjet inks included 1,2-decanediol as the 1,2-alkanediol having 10 or more carbon atoms, and a second polyurethane-based dispersant as the free dispersant.

An additional comparative example of the aqueous inkjet ink was also prepared (referred to as “Comp. Ink 2”). The comparative aqueous inkjet ink did not include any 1,2-alkanediol having 10 or more carbon atoms. However, the comparative aqueous inkjet ink did include the second polyurethane-based dispersant as a free dispersant.

The general formulation of each of these aqueous inkjet inks (example and comparative) is shown in Table 2, with the wt % active of each component that was used. Additionally, a 5 wt % potassium hydroxide aqueous solution was added to each of the ink compositions until a pH of about 8.5 was achieved.

TABLE 2

| | | Comp. | | | | | | |
|---|---|---|---|---|---|---|---|---|
| | Specific | lnk 1 | Ex lnk 7 | Ex. lnk 8 | Ex. lnk 9 | Ex. lnk 10 | Ex. lnk 11 | Ex lnk 12 |
| Ingredient | Component | (wt %) | (wt %) | (wt %) | (wt %) | (wt %) | (wt %) | (wt %) |
| 1,2-alkanediol | 1,2-decanediol | --- | 0.1 | 0.2 | 0.3 | 0.5 | 0.75 | 1 |
| having 10 or | | | | | | | | |
| more carbon | | | | | | | | |
| atoms | | | | | | | | |
| Free | Polyurethane- | 1 | 1 | 1 | 1 | 1 | 1 | 1 |
| dispersant | based dispersant | | | | | | | |
| Colorant | Polymer dispersed | 4.3 | 4.3 | 4.3 | 4.3 | 4.3 | 4.3 | 4.3 |
| | magenta pigment | | | | | | | |
| Co-solvent | 2-pyrrolidone | 7.5 | 7.5 | 7.5 | 7.5 | 7.5 | 7.5 | 7.5 |
| | Triethylene Glycol | 10 | 10 | 10 | 10 | 10 | 10 | 10 |
| | di(2-hydroxyethyl)- | 4 | 4 | 4 | 4 | 4 | 4 | 4 |
| | 5,5- | | | | | | | |
| | dimethylhydantoin | | | | | | | |
| Surfactant | Non-ionic | 0.6 | 0.6 | 0.6 | 0.6 | 0.6 | 0.6 | 0.6 |
| | surfactants | | | | | | | |
| Biocide | Mixture of | 0.23 | 0.23 | 0.23 | 0.23 | 0.23 | 0.23 | 0.23 |
| | ACTICIDE ®B20 | | | | | | | |
| | and ACTICIDE ® | | | | | | | |
| | M20 | | | | | | | |
| Water | Deionized water | Balance | Balance | Balance | Balance | Balance | Balance | Balance |

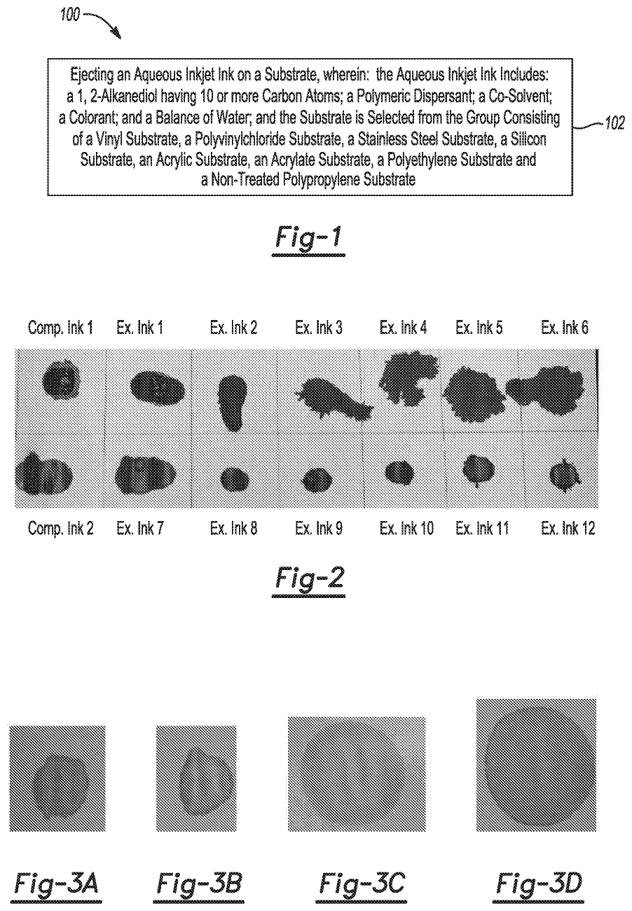

25 μL of each of comparative ink 1 and example ink 1 were placed on offset coated media (Sterling Ultra Gloss). 10 μL of each of the other example inks and of comparative ink 2 were placed on offset coated media (Sterling Ultra Gloss). FIG. 2 shows the aqueous inkjet inks (example and comparative) applied on the offset coated media.

For Ex. Ink 1 through Ex. Ink 6, the wettability of the aqueous inkjet ink on the offset coated media increased as the amount of the 1,2-decanediol was increased. The increased wettability is indicated by the increased spreading of the aqueous inkjet ink. This increased wettability indicates that the presence of the 1,2-alkanediol having 10 or more carbon atoms may improve the wettability of the aqueous inkjet ink disclosed herein on offset coated media.

For Ex. Ink 7 through Ex. Ink 12, increasing the amount of the 1,2-decanediol had little effect on the wettability of the aqueous inkjet ink on the offset coated media. It is believed that the component of these inks (e.g., the surfactants, dispersants, etc.) may have over solubilized the 1,2-decanediol. This indicates that the presence and amount of the other components in the aqueous inkjet ink may affect the ability of the 1,2-alkanediol having 10 or more carbon atoms to improve the wettability of the aqueous inkjet ink disclosed herein on offset coated media.

### Example 2

Two additional examples of the aqueous inkjet ink disclosed herein were prepared (referred to as “Ex. Ink 13” and “Ex. Ink 14”). The wetting package in Ex. Ink 13 included 1,2-decanediol as the 1,2-alkanediol having 10 or more carbon atoms. Ex. Ink 13 did not include a free dispersant. The wetting package in Ex. Ink 14 included 1,2-decanediol as the 1,2-alkanediol having 10 or more carbon atoms, and the first polyurethane-based dispersant as the free dispersant.

Two additional comparative examples of the aqueous inkjet ink were also prepared (referred to as “Comp. Ink 3” and “Comp. Ink 4”). The comparative aqueous inkjet inks did not include any 1,2-alkanediol having 10 or more carbon atoms. The comparative aqueous inkjet inks also did not include any free dispersant.

The general formulation of each of these aqueous inkjet inks (example and comparative) is shown in Table 3, with the wt % active of each component that was used. Additionally, a 5 wt % potassium hydroxide aqueous solution was added to each of the ink compositions until a pH of about 8.5 was achieved.

TABLE 3

| | | Comp. | Comp. | Ex. | Ex. |
|---|---|---|---|---|---|
| | Specific | Ink 3 | Ink 4 | Ink 13 | Ink 14 |
| Ingredient | Component | (wt %) | (wt %) | (wt %) | (wt %) |
| 1,2- | 1,2-decanediol | — | — | 1 | 1 |
| alkanediol | | | | | |
| having 10 or | | | | | |
| more carbon | | | | | |
| atoms | | | | | |
| Free | Polyurethane- | — | — | — | 1 |
| dispersant | based dispersant | | | | |
| Colorant | Cyan Dye | 0.4 | 0.4 | 0.4 | 0.4 |
| Co-solvent | 2-pyrrolidone | 10 | 10 | 10 | 10 |
| | 1- | 5 | 5 | 5 | 5 |
| | (2-hydroxyethyl)- | | | | |
| | 2-pyrrolidone | | | | |
| Saccharide | Sorbitol | 5 | 5 | 5 | 5 |
| Surfactant | Sodium dodecyl | — | 0.15 | 0.15 | 0.15 |
| | sulfate | | | | |
| Water | Deionized water | Balance | Balance | Balance | Balance |

25 μL of each of the aqueous inkjet inks (example and comparative) were placed on offset coated media (Sterling Ultra Gloss). FIG. 3A shows Comp. Ink 3 applied on the offset coated media; FIG. 3B shows Comp. Ink 4 applied on the offset coated media; FIG. 3C shows Ex. Ink 13 applied on the offset coated media; and FIG. 3D shows Ex. Ink 14 applied on the offset coated media.

As shown in FIGS. 3A through 3D, the wettability of the example aqueous inkjet inks on the offset coated media was improved compared to the comparative aqueous inkjet inks. As also shown in FIGS. 3A through 3D, the greatest increase in the wettability of the aqueous inkjet ink on the offset coated media was when the 1,2-decanediol and the free dispersant further were included (Ex. Ink 14). The increased wettability is indicated by the increased spreading of the aqueous inkjet ink.

These results further indicate that the presence of the 1,2-alkanediol having 10 or more carbon atoms may improve the wettability of the aqueous inkjet ink disclosed herein on offset coated media. These results also indicate that the presence of the free dispersant may enhance the ability of the 1,2-alkanediol having 10 or more carbon atoms to improve the wettability of the aqueous inkjet ink disclosed herein on offset coated media.

### Example 3

One magenta comparative ink and three magenta example inks were prepared as shown in Table 4.

TABLE 4

| | | Comp. | Ex. | Ex. | Ex. |
|---|---|---|---|---|---|
| | Specific | Ink 5 | Ink 15 | Ink 16 | Ink 17 |
| Ingredient | Component | (wt %) | (wt %) | (wt %) | (wt %) |
| 1,2-alkanediol | 1,2-decanediol | — | 1.0 | 1.0 | 1.0 |
| having 10 | | | | | |
| or more | | | | | |
| carbon atoms | | | | | |
| 1,2-alkanediol | 1,2-hexanediol | 4.0 | — | 4.0 | 4.0 |
| having 6 | | | | | |
| or fewer | | | | | |
| carbon atoms | | | | | |
| 1,2-alkanediol | 1,2-octanediol | 2.0 | — | — | 2.0 |
| having 7 or 8 | | | | | |
| carbon atoms | | | | | |
| Colorant | CAB-O-JET ® | 4.5 | 4.5 | 4.5 | 4.5 |
| | 465M | | | | |
| Co-solvent | 2-pyrrolidone | 10 | 14 | 10 | 10 |
| Saccharide | Sorbitol | 3 | 3 | 3 | 3 |
| Surfactant | Sodium dodecyl | 0.15 | 0.15 | 0.15 | 0.15 |
| | sulfate | | | | |
| Water | Deionized water | Balance | Balance | Balance | Balance |

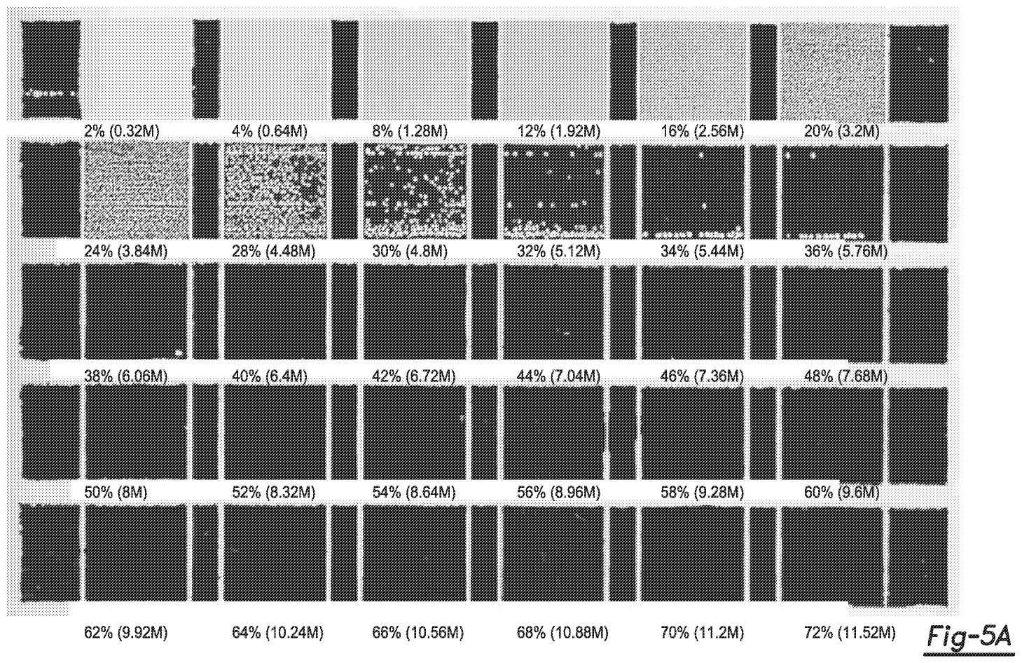

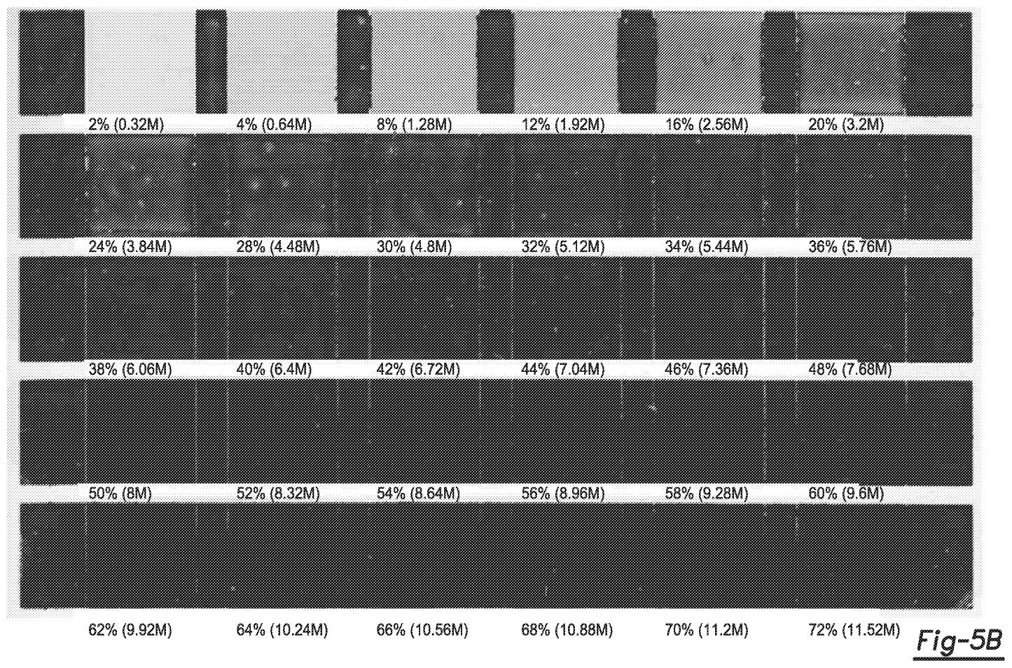

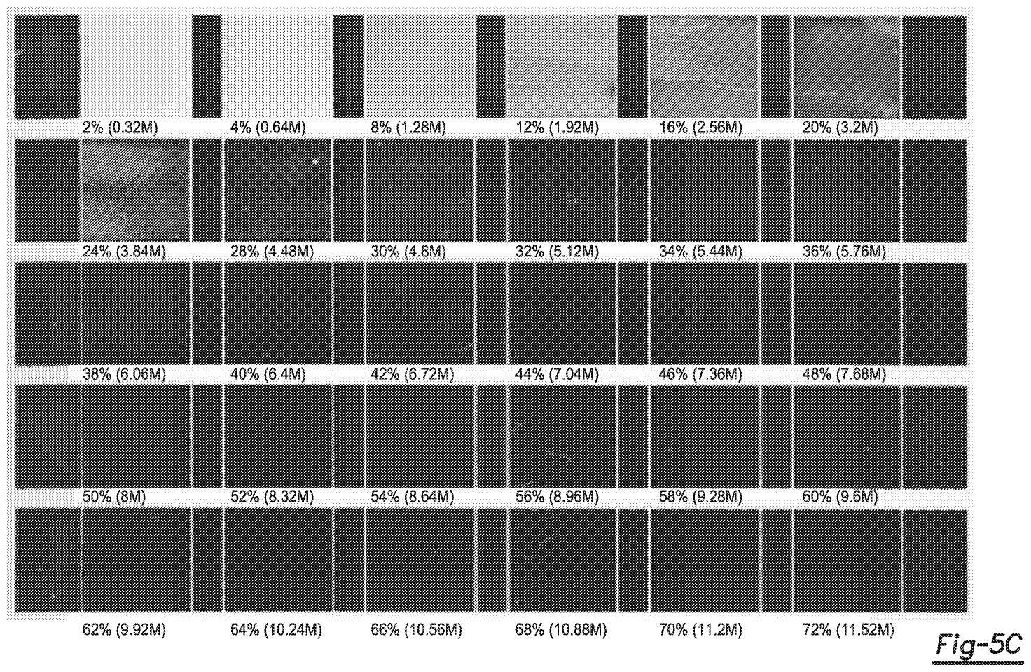

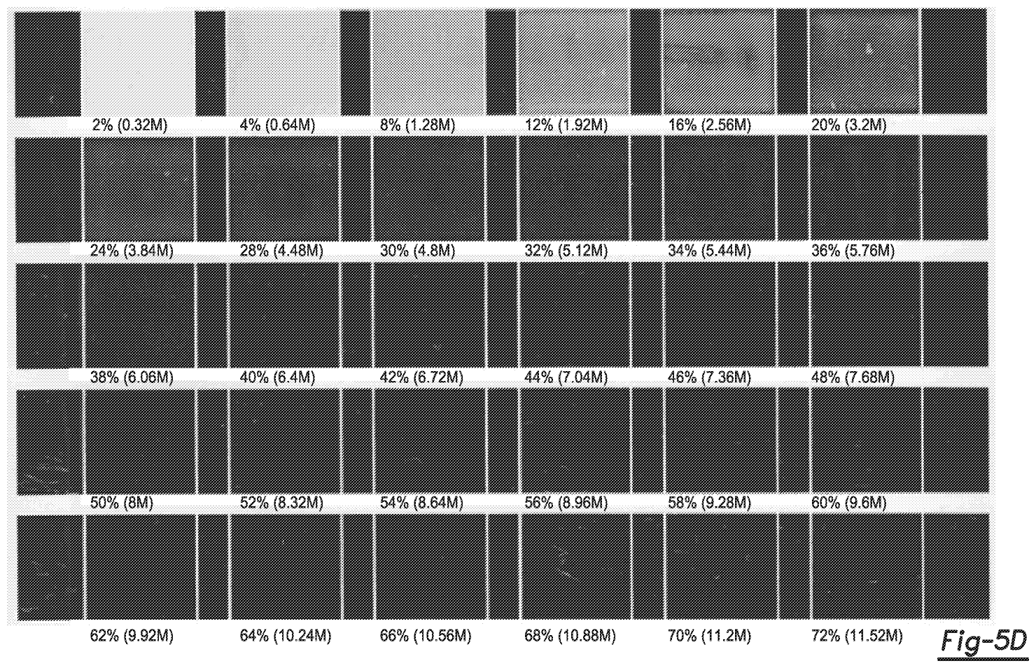

Comp. Ink 5 and Ex. Ink 17 were printed on offset coated media (Sterling Ultra Gloss). Comp. Ink 5 and Ex. Inks 15-17 were printed on polyvinyl chloride. The comparative and example inks were printed as square blocks with different levels of ink deposited based on the print mode. Rectangular blocks printed before each square block was a warm-up block. Table 5 illustrates the blocks in each of FIGS. 5A, 5B and 6A-6D, showing the level of ink printed in each of the blocks as a percentage, and as the number of drops printed in a pixel. As an example, 0.32 M refers to 0.32 magenta drops per given pixel.

TABLE 5

| | | | | | |
|---|---|---|---|---|---|
| 2% | 4% | 8% | 12% | 16% | 20% |
| 0.32M | 0.64M | 1.28M | 1.92M | 2.56M | 3.2M |
| 24% | 28% | 30% | 32% | 34% | 36% |
| 3.84M | 4.48M | 4.8M | 5.12M | 5.44M | 5.76M |
| 38% | 40% | 42% | 44% | 46% | 48% |
| 6.06M | 6.4M | 6.72M | 7.04M | 7.36M | 7.68M |
| 50% | 52% | 54% | 56% | 58% | 60% |
| 8M | 8.32M | 8.64M | 8.96M | 9.28M | 9.6M |
| 62% | 64% | 66% | 68% | 70% | 72% |
| 9.92M | 10.24M | 10.56M | 10.88M | 11.2M | 11.52M |

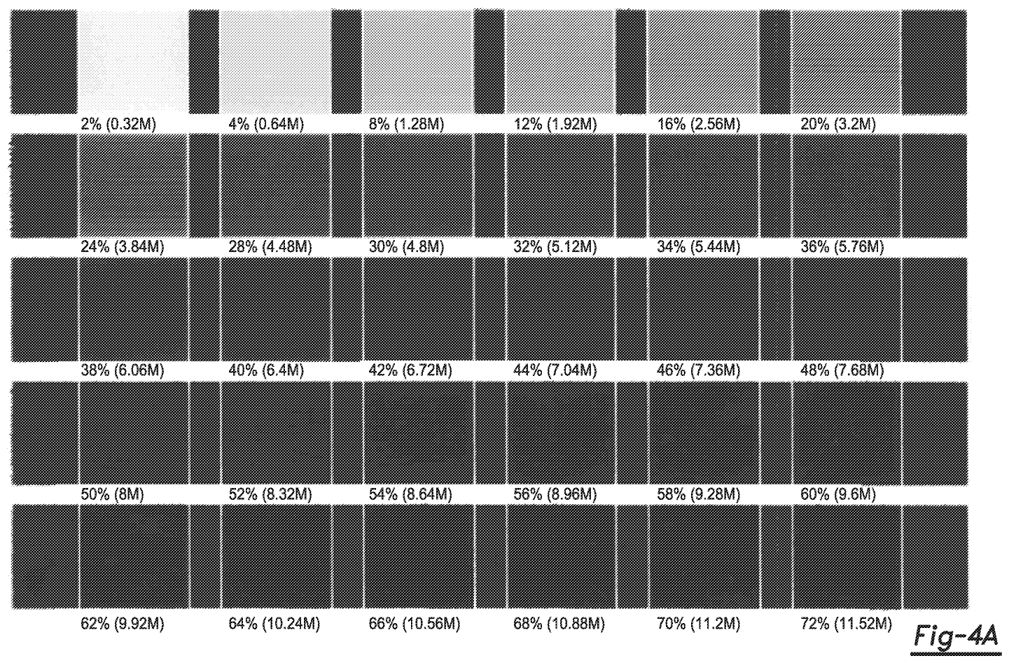

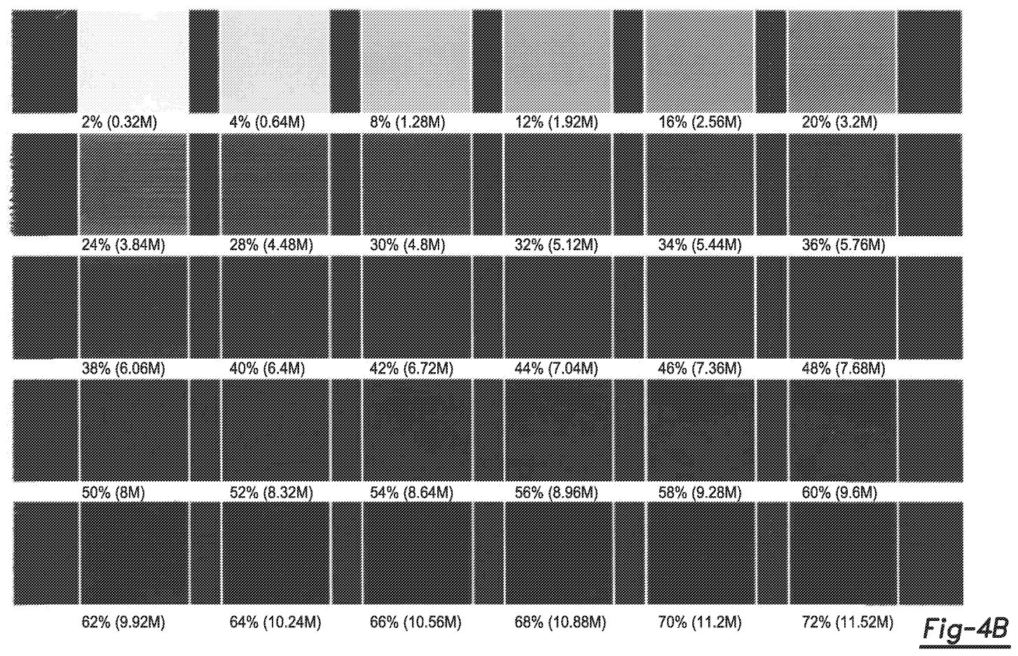

The results (reproduced in black and white) for Comp. Ink 5 and Ex. Ink 17 on offset coated media are shown, respectively, in FIGS. 4A and 4B. The color uniformity across each block was improved for Ex. Ink 17, and the bleed between the square blocks and the rectangular blocks was reduced for Ex. Ink 17.

The results (reproduced in black and white) for Comp. Ink 5 and Ex. Inks 15 through 17 on polyvinyl chloride are shown, respectively, in FIGS. 5A, 5B, 5C, and 5D. As shown in FIG. 5A, Comp. Ink 5 exhibited poor color uniformity on the PVC medium. Comp. Ink 5 also experienced color retraction, as evidenced by the larger white spaces between the square blocks and the rectangular blocks. As shown in FIG. 5B, Ex. Ink 15 exhibited better uniformity than Comp. Ink 5, and did not experience color retraction. Rather, Ex. Ink 15 experienced some bleeding between the blocks. Both color uniformity and bleed were improved with Ex. Ink 16 (FIG. 5C) and Ex. Ink 17 (FIG. 5D), with Ex. Ink 17 showing the best results on PVC. These results indicate that the example inks disclosed herein are particularly suitable for forming prints with desirable print attributes on low energy, hydrophobic media.

Inks similar to Ex. Inks 16 and 17 were formulated with the addition of 2.0 wt % of a polyurethane free dispersant. The ink similar to Ex. Ink 17 included 5 wt % 1,2-hexanediol and 0.2 wt % 1,2-octanediol. These inks were tested for decap. While the results are not shown, both of these inks performed well in terms of decap and nozzle health. However, ink including the trio of alkanediols performed better than the ink including the duo of alkanediols.

It is to be understood that the ranges provided herein include the stated range and any value or sub-range within the stated range, as if such values or sub-ranges were explicitly recited. For example, from about 0.1 wt % active to about 1 wt % active should be interpreted to include not only the explicitly recited limits of from about 0.1 wt % active to about 1 wt % active, but also to include individual values, such as about 0.25 wt % active, about 0.67 wt % active, about 0.79 wt % active, about 0.97 wt % active, etc., and sub-ranges, such as from about 0.13 wt % active to about 0.82 wt % active, from about 0.25 wt % active to about 0.762 wt % active, from about 0.31 wt % active to about 0.98 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An aqueous inkjet ink, comprising:
a wetting package including:
a 1,2-alkanediol having 10 or more carbon atoms; and
a free polymeric dispersant;
a co-solvent;
a colorant; and
a balance of water.

2. The aqueous inkjet ink as defined in claim 1 wherein the wetting package further includes a 1,2-alkanediol having 6 or fewer carbon atoms.

3. The aqueous inkjet ink as defined in claim 2 wherein the 1,2-alkanediol having 6 or fewer carbon atoms is present in the wetting package in an amount ranging from about 1 wt % active to about 10 wt % active, based on a total weight of the aqueous inkjet ink.

4. The aqueous inkjet ink as defined in claim 1 wherein the 1,2-alkanediol having 10 or more carbon atoms is selected from the group consisting of 1,2-decanediol, 1,2-dodecanediol, 1,2-tetradecanediol, 1,2-hexadecanediol, and combinations thereof.

5. The aqueous inkjet ink as defined in claim 1 wherein the 1,2-alkanediol having 10 or more carbon atoms is present in the wetting package in an amount ranging from about 0.05 wt % active to about 2 wt % active, based on a total weight of the aqueous inkjet ink.

6. The aqueous inkjet ink as defined in claim 1 wherein the free polymeric dispersant is a polyurethane-based dispersant or a latex dispersant.

7. The aqueous inkjet ink as defined in claim 1 wherein the free polymeric dispersant is present in the wetting package in an amount ranging from greater than 0 wt % active to about 10 wt % active, based on a total weight of the aqueous inkjet ink.

8. The aqueous inkjet ink as defined in claim 1 wherein the colorant is a pigment present in an amount ranging from about 1.5 wt % active to about 6 wt % active, based on a total weight of the aqueous inkjet ink.

9. The aqueous inkjet ink as defined in claim 1 wherein the wetting package further includes:
a 1,2-alkanediol having 6 or fewer carbon atoms; and
a 1,2-alkanediol having 7 or 8 carbon atoms.

10. The aqueous inkjet ink as defined in claim 9 wherein:
the 1,2-alkanediol having 10 or more carbon atoms is present in the wetting package in an amount ranging from about 0.05 wt % active to about 2 wt % active, based on a total weight of the aqueous inkjet ink;
the 1,2-alkanediol having 6 or fewer carbon atoms is present in the wetting package in an amount ranging from about 1 wt % active to about 10 wt % active, based on a total weight of the aqueous inkjet ink; and
1,2-alkanediol having 7 or 8 carbon atoms is present in the wetting package in an amount ranging from about 0.05 wt % active to about 4 wt % active, based on a total weight of the aqueous inkjet ink.

11. The aqueous inkjet ink as defined in claim 1, further comprising a saccharide.

12. An aqueous inkjet ink, consisting of:
a wetting package consisting of:
a 1,2-alkanediol having 10 or more carbon atoms; or
the 1,2-alkanediol having 10 or more carbon atoms, and 1,2-hexanediol; or
the 1,2-alkanediol having 10 or more carbon atoms, 1,2-octanediol, and 1,2-hexanediol;
a polymeric dispersant;
a co-solvent selected from the group consisting of lactams, formamides, acetamides, and long chain alcohols;
a colorant;
an additive selected from the group consisting of a surfactant, a saccharide, an anti-kogation agent, an anti-decel agent, a biocide, a chelating agent, a rheology modifier, a pH adjuster, and a combination thereof, wherein:
the surfactant is selected from the group consisting of an anionic surfactant, a fluorine surfactant, a biosurfactant, a polyoxyethylene alkyl ether, a polyoxyethylene alkyl phenyl ether, a polyoxyethylene fatty acid ester, a sorbitan fatty acid ester, a polyoxyethylene sorbitan fatty acid ester, a polyoxyethylene sorbitol fatty acid ester, a glycerin fatty acid ester, a polyoxyethylene glycerin fatty acid ester, a polyglycerin fatty acid ester, a polyoxyethylene alkylamine, a polyoxyethylene fatty acid amide, an alkylalkanolamide, a polyethylene glycol polypropylene glycol block copolymer, an acetylene glycol, and a polyoxyethylene adduct of acetylene glycol; and
the chelating agent is selected from the group consisting of 4,5-dihydroxy-1,3-benzenedisulfonic acid disodium salt monohydrate; ethylenediaminetetraacetic acid; and hexamethylenediamine tetra(methylene phosphonic acid), potassium salt; and
a balance of water.

13. The aqueous inkjet ink as defined in claim 12 wherein the polymeric dispersant is a free polymeric dispersant.

14. A printing method, comprising:
ejecting an aqueous inkjet ink on a substrate, wherein:
the aqueous inkjet ink includes:
a 1,2-alkanediol having 10 or more carbon atoms;
a polymeric dispersant;
a co-solvent;
a colorant; and
a balance of water; and
the substrate is selected from the group consisting of a vinyl substrate, a polyvinylchloride substrate, a stainless steel substrate, a silicon substrate, an acrylic substrate, an acrylate substrate, a polyethylene substrate, and a non-treated polypropylene substrate.

15. The printing method as defined in claim 14 wherein the polymeric dispersant is a free polymeric dispersant.
